(19) United States
(12) Patent Application Publication
(10) Pub. No.: US 2019/0084203 A1
(43) Pub. Date: Mar. 21, 2019

(54) METHOD FOR EMBEDDING ELASTOMER SEALING MATERIALS ON THE THREADS OF PLASTIC FITTINGS USING TWO STAGE INJECTION MOLDING

(71) Applicant: Elysée Piping Systems Limited, London (GB)

(72) Inventor: Panos Protopapas, Kaimakli (Nicosia) (CY)

(21) Appl. No.: 15/533,122

(22) PCT Filed: Dec. 4, 2015
(86) PCT No.: PCT/IB2015/002305

§ 371 Date: Jun. 5, 2017

Related U.S. Application Data
(60) Provisional application No. 62/087,901, filed on Dec. 5, 2014.

(51) Int. Cl. B29C 45/16; F16L 15/04

(52) U.S. Cl. CPC B29C 45/1676; B29L 2031/24; F16L 15/04

(57) ABSTRACT

The present invention is a method of sealing threaded connections of plastic fittings with other plastic fittings, or with fittings of any other materials, in order to ensure a non-leaking connection without applying any additional sealing means. This is achieved through the incorporation of an elastomer sealing material on the threads of one of the plastic fittings during its production process, using a two stage injection moulding method.

### BACKGROUND

Traditionally plastic fittings are produced using standard injection molding technology where the whole body of the fitting and the threads are produced in one operation using one hard plastic material. The technical properties of the fittings are optimized to strengthen the body of the fitting according to standards, with respect to stand pressures, impacts and long-term use in different environment and temperatures. Since the materials are optimized for strength and hardness, additional sealing materials are added to ensure sealing of the threads of the fittings after assembly. To seal the connection during the assembly of the two fittings, a sealing material such as Polytetrafluoroethylene (PTFE) sealing tape or cords, thread glue or traditional hemp or non-curing sealing compound is used. The sealing material is covering the area where the threads of the one fitting interfere with the threads of the other fitting. During assembly, the sealing material is being squeezed by the fitting and thus creating a sealing compound.

Adding sealing material through the installation process of the fitting is time consuming and prone for error. If the sealing material is not applied correctly or is not in the correct position after the assembly of the fittings, the sealing area will leak. Furthermore, in the case that the fittings are disassembled, the sealing material has to be substituted with a new one.

### STATEMENT OF INVENTION

The invention will be described in further detail below with reference to the attached drawings in which:

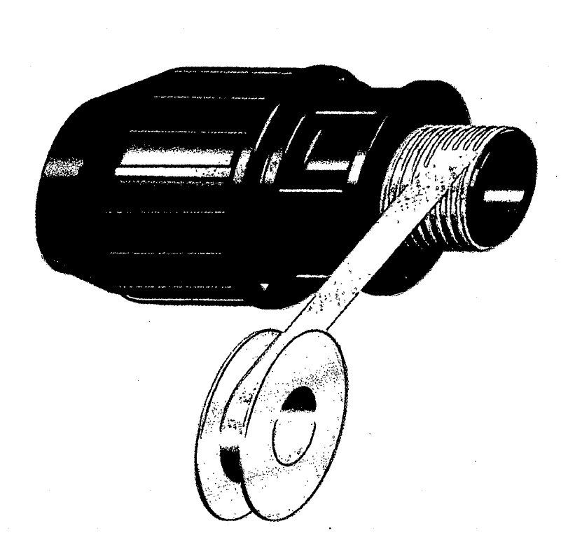

FIG. 1. illustrates a connection fitting according to the prior art;

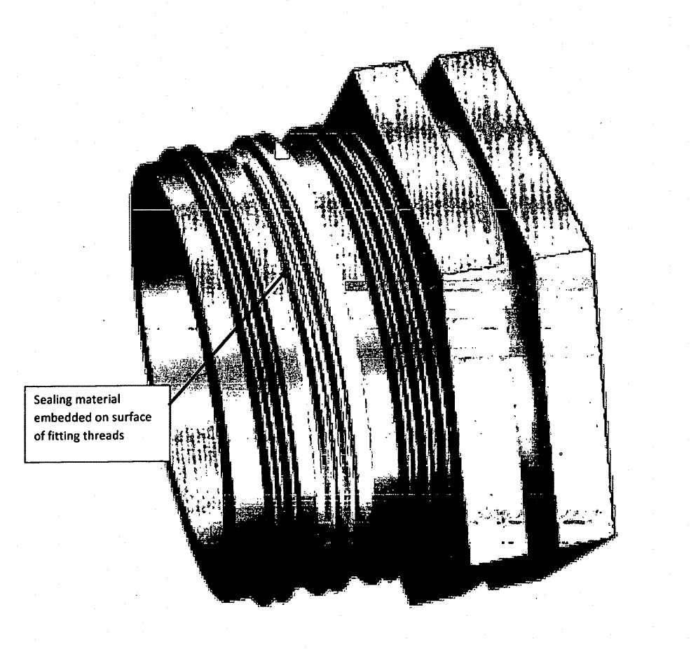

FIG. 2. illustrates the invention embedded on a fitting;

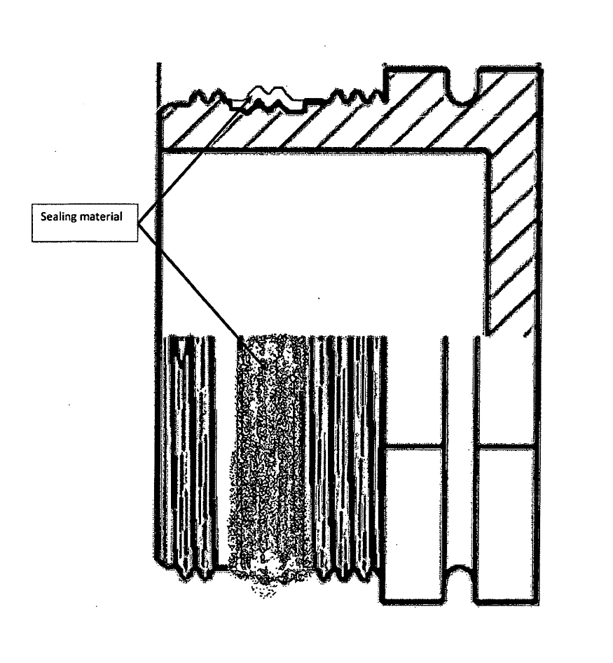

FIG. 3. illustrates a cross-sectional side view of the application of the invention;

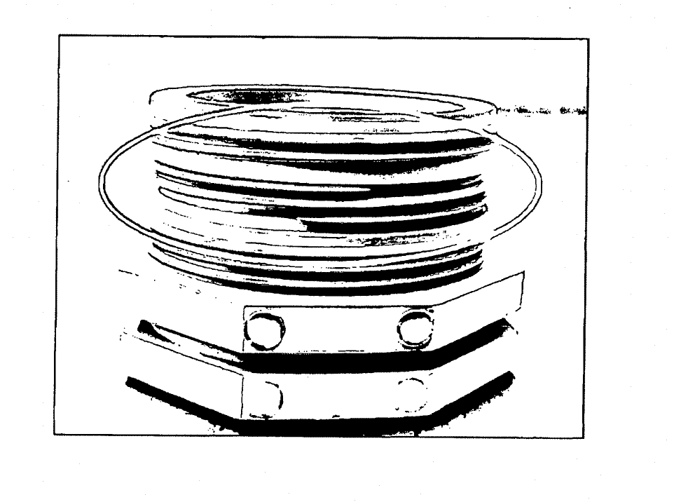

FIG. 4. illustrates the part after the first injection stage;

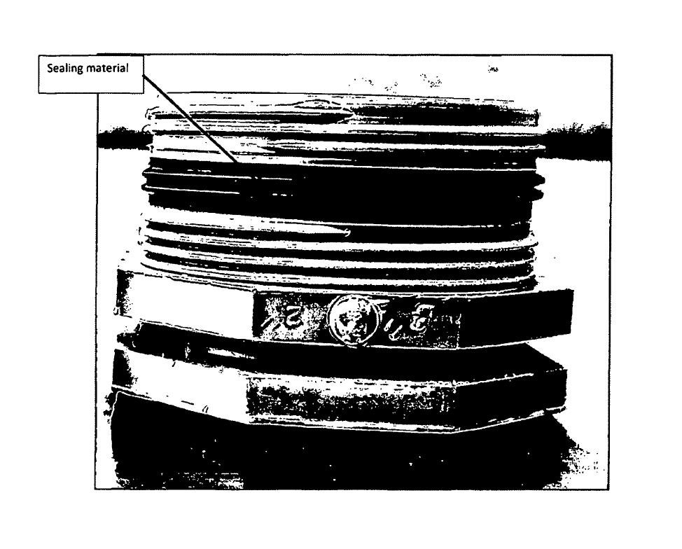

FIG. 5. illustrates the part after the second injection stage;

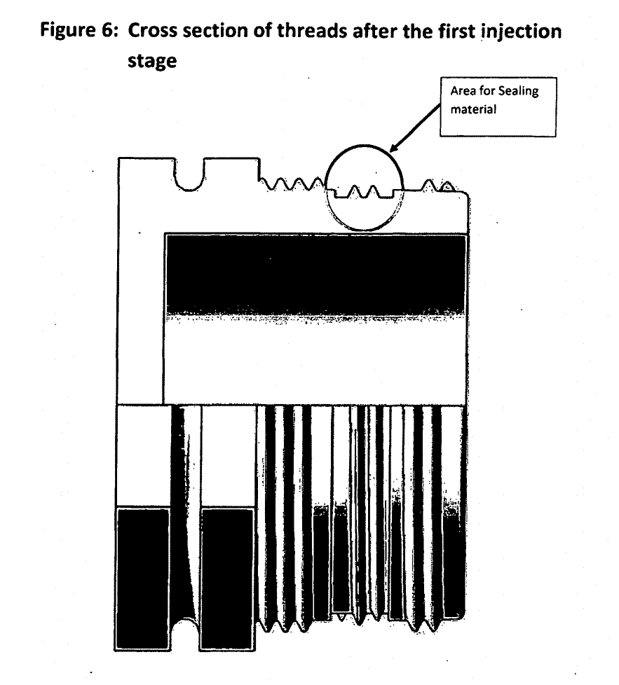

FIG. 6. illustrates a cross section of the thread after the first injection stage;

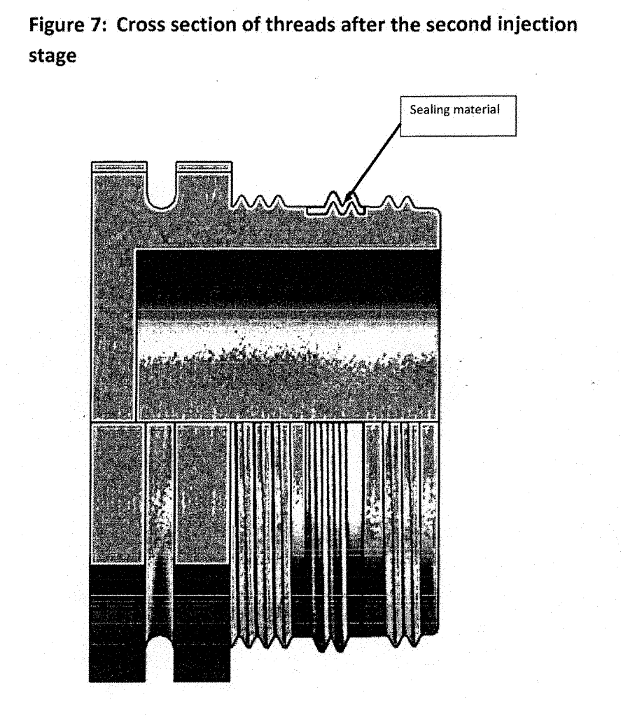

FIG. 7. illustrates a cross section of the thread after the second injection stage;

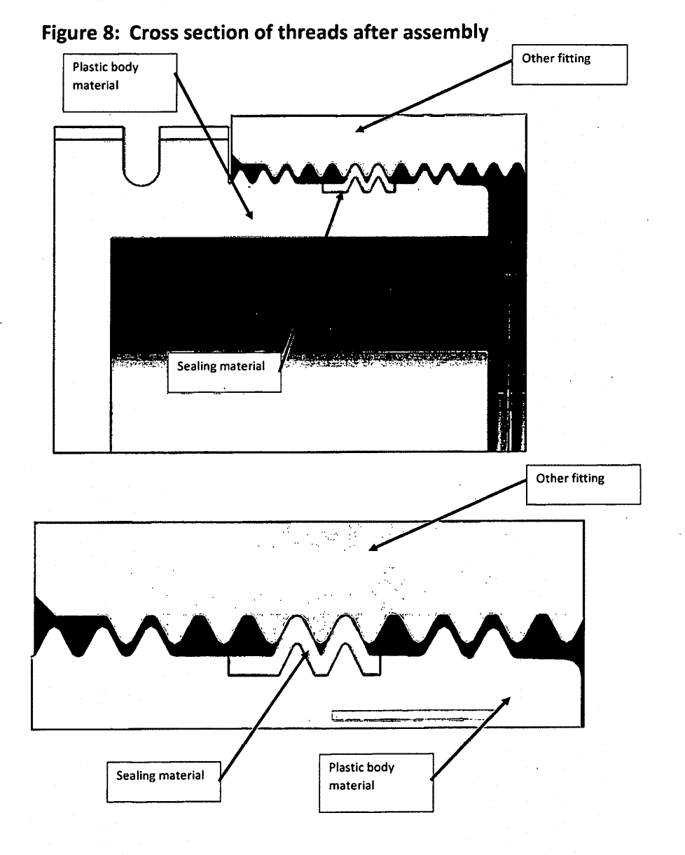

FIG. 8. Illustrates a cross section of the threads after assembly with another part.

As shown in FIG. 2, the new invention is a way to embed Elastomer sealing material directly on the threads of the fitting during the production (injection process) of the fitting so that there is no need to apply additional sealing material during installation of the fitting.

The method for producing the fittings with the sealing material is utilizing a two stage injection process where the body of the fitting is produced in two stages with two different materials:
1. The first stage of the injection process is using the normal plastic material and forming the body and the threads of the fitting with the technical properties required according to standards. The result of 1^{st} stage can be seen in FIG. 4.
2. During the second stage, the Elastomer sealing material is added on the threads and is adhered to the body by the heat of the melted Elastomer sealing material, so that the two materials become attached. The result of 2^{nd} stage can be seen in FIG. 5.

This way, the Elastomer sealing material is embedded in the product and the Elastomer sealing material is always in the best position to ensure the optimal sealing of the threads between the two fittings being assembled.

To strengthen the threads in the sealing area, so that they are rigid enough to ensure proper sealing, a supportive thread which is lower than the normal thread is designed to be under the Elastomer sealing material. This thread is created together with the main body during the first injection stage (see FIG. 6). The Elastomer sealing material is then injected on top of this lower thread in the second injection stage, with a height higher than the normal threads (see FIG. 7), so that the Elastomer sealing material fills the gap between the threads of the two fittings when they are assembled, ensuring proper sealing between the two fittings.

Thickness, shape and properties of the Elastomer sealing material are optimised to achieve ideal sealing interference, without increasing the required operational torque required for assembly (see FIG. 8). Since the design of the Elastomer sealing material makes it shaped as the thread, the Elastomer sealing material is not “chewed” between the threads of the fittings during installation, but merely squeezed enough to fill the gap between the threads. This design makes sure that the Elastomer material is not removed from the threads or damaged during assembly or disassembling, thus removing the risk of leakage after installation and the requirement for applying new sealing materials when re-assembled.

1. A method for embedding Elastomer sealing material directly on the threads of the fitting during the production (injection process) of the fitting, so that there is no need to apply additional sealing material during installation of the fitting, being characterized by the following two stages with two different materials:
The first stage of the injection process is using the normal plastic material and forming the body and the threads of the fitting with the technical properties required according to standards.
During the second stage, the Elastomer sealing material is added on the threads and is adhered to the body by the heat of the melted Elastomer sealing material, so that the two materials become attached.

2. A method according to claim 1, characterized by the addition of a supportive thread, which is lower than the normal thread, under the Elastomer sealing material, created together with the main body during the first injection stage, so that the threads in the sealing area are rigid enough to ensure proper sealing, the Elastomer sealing material being then injected on top of this lower thread in the second injection stage, with a height higher than the normal threads, in order for the Elastomer sealing material to fill the gap between the threads of the two fittings when they are assembled, thus ensuring proper sealing between the two fittings.
